(19) United States
(12) Patent Application Publication
(10) Pub. No.: US 2016/0284150 A1
(43) Pub. Date: Sep. 29, 2016

(54) System And Method For Preparing Test Ballots And For Testing An Electronic Voting Machine

(71) Applicant: Jeff DeLongchamp, Belmont, MI (US)

(72) Inventor: Jeff DeLongchamp, Belmont, MI (US)

(21) Appl. No.: 15/083,149

(22) Filed: Mar. 28, 2016

Related U.S. Application Data
(60) Provisional application No. 62/138,667, filed on Mar. 26, 2015.

(51) Int. Cl. G07C 13/00

(52) U.S. Cl. CPC G07C 13/00; G06Q 2230/00

(57) ABSTRACT

A system for the preparing of test ballots and for testing an electronic voting machine. The system provides for the building of the ballot test chart through an easy to utilize entry method. Once the data has been entered for every race and issue on the ballot, the system creates a test chart of ballots. The system not only creates the chart for ballots, but also optimizes the test chart so as to minimize the number of ballots that are to be utilized. The user can then complete a series of ballots following the test chart, or, alternatively, a series of ballots can be created and saved as a PDF file corresponding to the ballots that are to be created with the test chart.

### CROSS-REFERENCE TO RELATED APPLICATION

This application claims priority from U.S. Provisional Patent Application Ser. No. 62/138,667, filed Mar. 26, 2015, entitled “System And Method For Preparing Test Ballots And For Testing An Electronic Voting Machine,” the entire disclosure of which is hereby incorporated by reference in its entirety.

### BACKGROUND OF THE DISCLOSURE

1. Field of the Disclosure

The disclosure relates in general to election and voting equipment, and more particularly, to a system and method for preparing test ballots and for testing an electronic voting machine. The system aids in building the testing set of ballots and the completion of the testing set of ballots. The system likewise is configured to complete the set of test ballots in some configurations.

2. Background Art

The use of electronic voting machines is well known in the art. Typically, a voter fills in a ballot using a pen or pencil. The completed ballot is introduced into a machine that can read the ballot markings made by the voter and can store the votes that were made on the ballot. Subsequently, the machine can tabulate the different votes and provide the results of the votes that were entered on that machine.

Typically, statutes govern the creation of methods of testing the different electronic voting machines. One example is the Michigan Election Law (MCL 168.1-168.992) accompanied by the Electronic Voting Systems Promulgated Rules (R 168.771-168.793). Typically, the statute sets forth the manner in which to build a test chart of the different test ballots. Essentially, the formed chart provides a template by which to create a set of test ballots.

Problematically, the rules tend to be difficult to follow and difficult to implement. Thus, the test chart that is created may be incorrect or may not have followed the rules properly. Such an error may not fully test the voting machine, which, in turn, would not catch coding errors. Generally, the purpose of the test is to catch such errors.

Additionally, when the rules are followed, and a chart is formed, ballots are to be completed. It is rarely the case that a brute force method of chart generation yields an optimum amount of ballots. Generally, such a method trades the number of ballots for the ease of completing the chart. There is typically a manner in which to optimize the number of ballots. However, such optimization is not readily apparent to one that is filling out the charts. Generally, the time required to attempt to optimize and reduce the number of ballots that need to be prepared far exceeds the time required and the cost associated with the creation of excess ballots.

### SUMMARY OF THE DISCLOSURE

The disclosure is directed to one or more computer storage media comprising computer-executable instructions for preparing a ballot test chart. The computer-executable instructions when executed by a computing device performing steps comprising: receiving information pertaining to an election; receiving information as to at least one of a candidate and a proposal; reviewing a set of rules for the election with the information received; determining a manner in which to mark a plurality of test ballots; and providing the manner in which to mark a plurality of test ballots in the form of a test ballot chart.

In some configurations, the computer-executable instructions when executed by a computing device perform additional steps comprising: optimizing the manner in which to mark a plurality of test ballots so as to minimize a quantity of test ballots required.

In some configurations, the step of receiving information of at least one of a candidate and a proposal further comprises the step of receiving information as to a plurality of candidates for a plurality of different races.

In some configurations, the step of receiving information as to at least one of a candidate and a proposal further comprises the step of: receiving information as to a plurality of proposals.

In some configurations, the computer-executable instructions when executed by a computing device perform additional steps comprising: providing a plurality of test ballots that are marked according to the test ballot chart.

In some configurations, the test ballot chart provides a plurality of rows corresponding to an individual ballot and a plurality of columns pertaining to the different candidates and proposals.

In another aspect of the disclosure, the disclosure is directed to a method for providing instructions for preparing a ballot test chart, comprising the steps of: receiving information pertaining to an election; receiving information as to at least one of a candidate and a proposal; reviewing a set of rules for the election with the information received; determining a manner in which to mark a plurality of test ballots; and providing the manner in which to mark a plurality of test ballots in the form of a test ballot chart.

In some configurations, the method further includes the step of: optimizing the manner in which to mark a plurality of test ballots so as to minimize a quantity of test ballots required.

In some configurations, the step of receiving information as to at least one of a candidate and a proposal further comprises the step of: receiving information as to a plurality of candidates for a plurality of different races.

In some configurations, the step of receiving information as to at least one of a candidate and a proposal further comprises the step of: receiving information as to a plurality of proposals.

In some configurations, the method further comprises the steps of providing a plurality of test ballots that are marked according to the test ballot chart.

In some configurations, the test ballot chart provides a plurality of rows corresponding to an individual ballot and a plurality of columns pertaining to the different candidates and proposals.

In yet another aspect of the disclosure, the disclosure is directed to a ballot test chart preparing system including: a receiving component configured to receive information pertaining to an election; a second receiving component configured to receive information as to at least one of a candidate and a proposal; a reviewing component configured to review a set of rules for the election with the information received; a determining component configured to determine a manner in which to mark a plurality of test ballots; and a providing component configured to provide the manner in which to mark a plurality of test ballots in the form of a test ballot chart.

In some configurations, the system includes an optimizing component configured to optimize the manner in which to mark a plurality of test ballots so as to minimize a quantity of test ballots required.

In some configurations, the second receiving component is configured to receive information as to a plurality of candidates for a plurality of different races.

In some configurations, the at least one of a candidate and a proposal further comprises information as to a plurality of proposals.

In some configurations, the system includes a providing component that is structurally configured to provide a plurality of test ballots that are marked according to the test ballot chart.

In some configurations, the test ballot chart provides a plurality of rows corresponding to an individual ballot and a plurality of columns pertaining to the different candidates and proposals.

### BRIEF DESCRIPTION OF THE DRAWINGS

The disclosure will now be described with reference to the drawings wherein:

FIG. 1 of the drawings is a schematic representation of the system of the present disclosure, showing in particular, the user's computing device communicating with the server through a network, to create a test chart from which a plurality of test ballots can be created for testing an electronic voting machine;

FIG. 2 of the drawings is a schematic representation of a general-purpose computing device; and

FIG. 3 of the drawings is a flow chart of the operation of the system of the present disclosure; and

FIG. 4 is a sample entry on the system of the present disclosure, showing, in particular, a general election, having a plurality of partisan races, non-partisan races and proposals;

FIG. 5 is a sample test chart created from the race entries of FIG. 4; AND

FIG. 6 of the drawings is a flow chart of the operation of the testing phase of the system.

### DETAILED DESCRIPTION OF THE DISCLOSURE

While this invention is susceptible of embodiment in many different forms, there is shown in the drawings and described herein in detail a specific embodiment with the understanding that the present disclosure is to be considered as an exemplification and is not intended to be limited to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

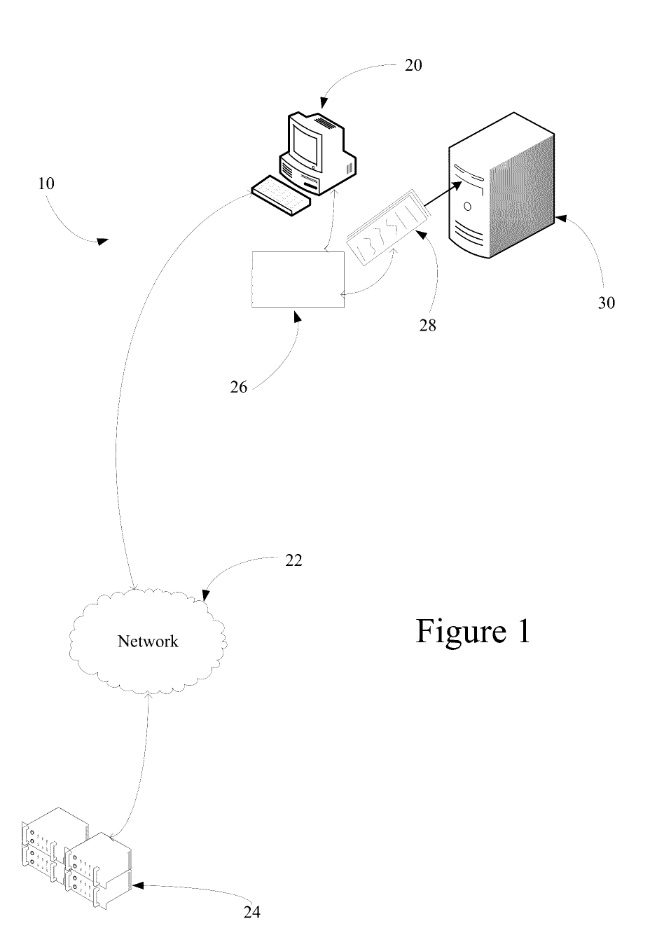

Referring now to the drawings and in particular to FIG. 1, a system 10 is disclosed for the preparing of test ballots and for testing an electronic voting machine. The system provides for the building of the ballot test chart through an easy to utilize entry method. Once the data has been entered for every race and issue on the ballot, the system creates a test chart of ballots. The system not only creates the chart for ballots, but also optimizes the test chart so as to minimize the number of ballots that are to be utilized. The user can then complete a series of ballots following the test chart, or, alternatively, a series of ballots can be created and saved as a PDF file corresponding to the ballots that are to be created with the test chart.

More particularly, the system contemplates the user utilizing a general-purpose computing device 20 and communicating through a network 22 (as will be explained) with a server 24 that is configured to facilitate the creation of a ballot test chart 26. Once created, the user can utilize the test chart 26 to fill in a plurality of test ballots 28 which are then run through the electronic voting machine 30.

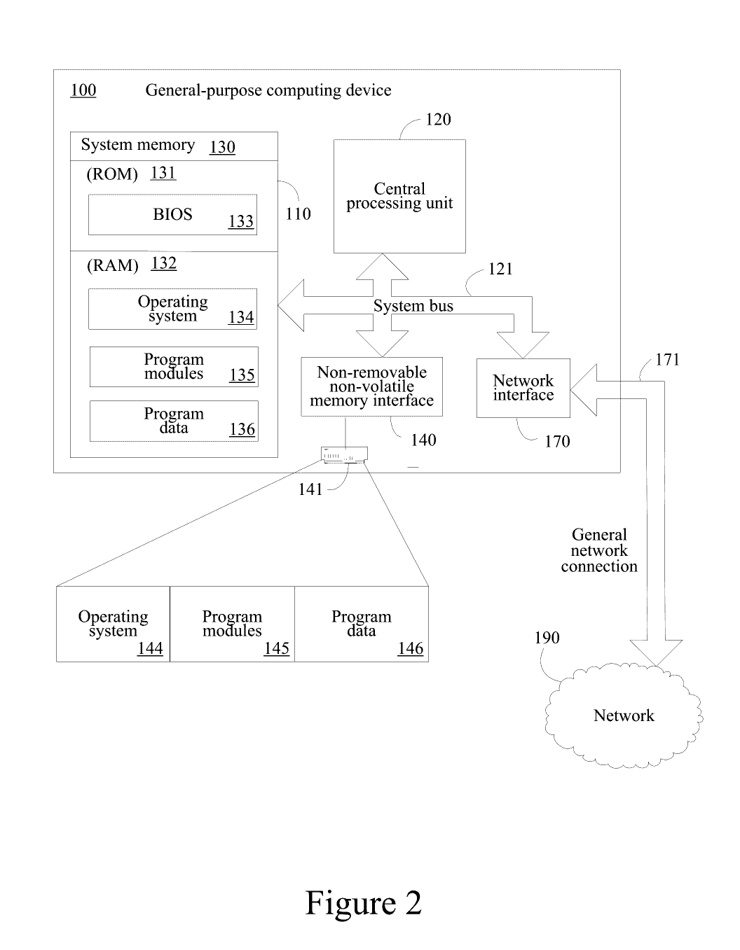

The preparation and the computation of the test chart and the ballots can be completed on a computing device. One such device is illustrated in the form of the exemplary general-purpose computing device 100 shown on FIG. 2. The exemplary general-purpose computing device 100 can include, but is not limited to, one or more central processing units (CPUs) 120, a system memory 130 and a system bus 121 that couples various system components including the system memory to the processing unit 120. The system bus 121 may be any of several types of bus structures including a memory bus or memory controller, a peripheral bus, and a local bus using any of a variety of bus architectures. Depending on the specific physical implementation, one or more of the CPUs 120, the system memory 130 and other components of the general-purpose computing device 100 can be physically co-located, such as on a single chip. In such a case, some or all of the system bus 121 can be nothing more than communicational pathways within a single chip structure and its illustration in FIG. 2 can be nothing more than notational convenience for the purpose of illustration.

The general-purpose computing device 100 also typically includes computer readable media, which can include any available media that can be accessed by computing device 100. By way of example, and not limitation, computer readable media may comprise computer storage media and communication media. Computer storage media includes media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the general-purpose computing device 100. Computer storage media does not include communication media. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

When using communication media, the general-purpose computing device 100 may operate in a networked environment via logical connections to one or more remote computers. The logical connection depicted in FIG. 2 is a general network connection 171 to the network 190, which can be a local area network (LAN), a wide area network (WAN) such as the Internet, or other networks. The computing device 100 is connected to the general network connection 171 through a network interface or adapter 170 that is, in turn, connected to the system bus 121. In a networked environment, program modules depicted relative to the general-purpose computing device 100, or portions or peripherals thereof, may be stored in the memory of one or more other computing devices that are communicatively coupled to the general-purpose computing device 100 through the general network connection 171. It will be appreciated that the network connections shown are exemplary and other means of establishing a communications link between computing devices may be used. It will also be understood that the general-purpose computing device may include location tracking information, such as current location, which can be provided through various means including wife, GPS, among others.

The general-purpose computing device 100 may also include other removable/non-removable, volatile/nonvolatile computer storage media. By way of example only, FIG. 2 illustrates a hard disk drive 141 that reads from or writes to non-removable, nonvolatile media. Other removable/non-removable, volatile/nonvolatile computer storage media that can be used with the exemplary computing device include, but are not limited to, magnetic tape cassettes, flash memory cards, digital versatile disks, digital video tape, solid state RAM 132, solid state ROM 131, and other computer storage media as described and delineated above. The hard disk drive 141 is typically connected to the system bus 121 through a non-removable memory interface such as interface 140.

The drives and their associated computer storage media discussed above and illustrated in FIG. 2, provide storage of computer readable instructions, data structures, program modules and other data for the general-purpose computing device 100. In FIG. 2, for example, hard disk drive 141 is illustrated as storing operating system 144, other program modules 145, and program data 146. Note that these components can either be the same as or different from operating system 134, other program modules 135 and program data 136 as well as bios 133. Operating system 144, other program modules 145 and program data 146 are given different numbers here to illustrate that, at a minimum, they are different copies.

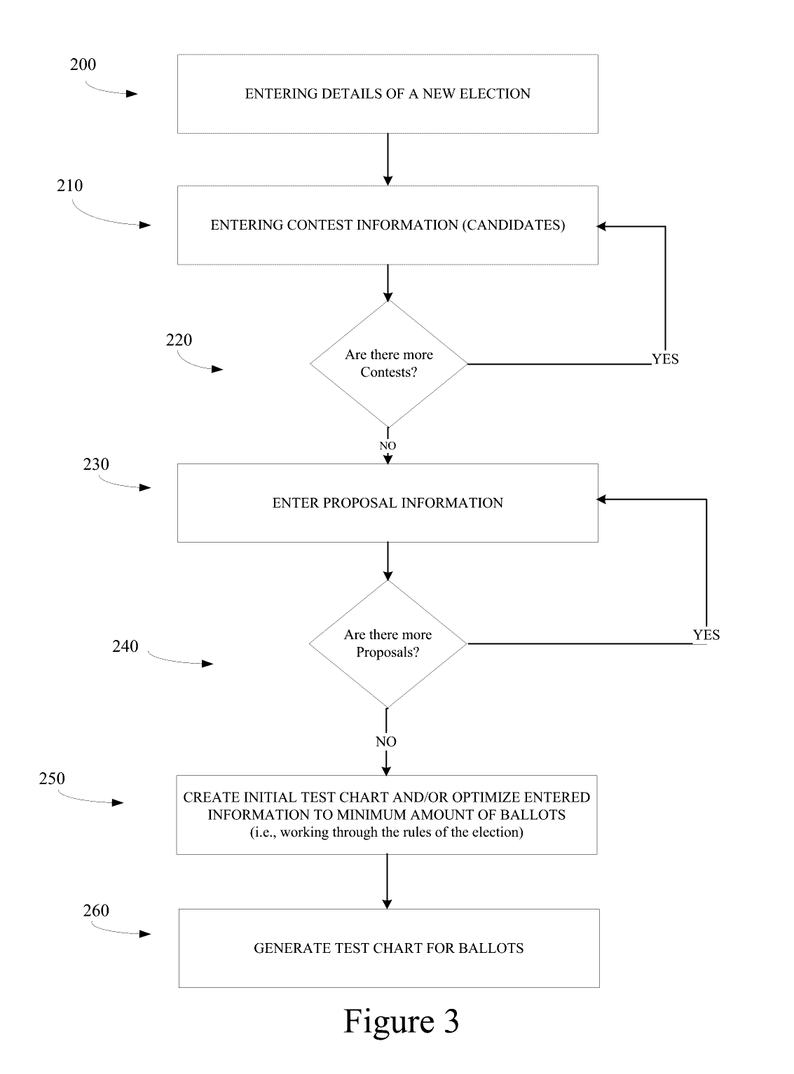

The operation of the system will be shown with reference to FIGS. 3 through 5. Prior to initiating a ballot, the user connects with the system (typically through the servers). It is contemplated that the system will operate in a browser environment. As such, a user can exchange data with a server through the web (i.e., through a secure or unsecure connection, or the like). In other configurations, it is contemplated that the software to create a ballot may be provided locally on a machine of the user.

Once logged into the system, the user can do a number of different steps. For example, the user may wish to create a new election, edit or complete a previously entered election, or merely review a previously entered election. Initially, the focus is on the creation of a new election by way of FIG. 3. At step 200, the user is prompted to provide information pertaining to the election, such as, for example, a township or precinct name, the date of the election, a purchase order number, the election type (i.e., general, primary, special, non-partisan, proposal etc.). Such information provides the system with an understanding of some of the parameters of the election.

Once the initial information is provided, the system is prepared to build the ballot test chart. Typically, a user has a ballot in hand when entering the information into the system. Of course, based on the information provided, the system may request additional information. For example, the system may inquire as to the different parties that may have a straight party ticket possibility (in the event that a general election was selected). The user can simply proceed down the different races and issues in order and provide this information to the system. Typically, the races are entered first (as they appear on ballots first), with the proposals being entered thereafter. Of course, the disclosure is not limited to such entry sequence (and the sequence can be changed post entry of the races and proposals).

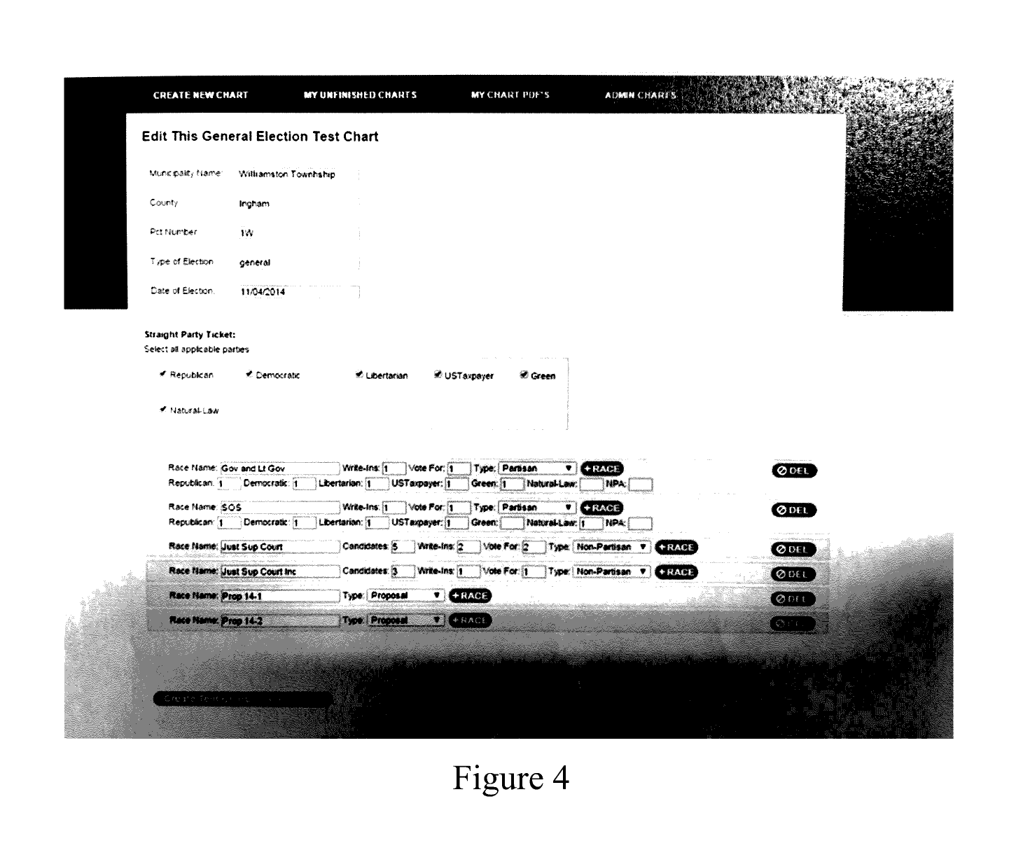

For example, and with reference to FIG. 3, at step 210, the user enters contest information, that is races that are directed to candidates. With reference to the sample preparation GUI shown in FIG. 4, to enter the first race, the user provides information as to the parameters of the race, in a race for Governor and Lt. Governor. Each race has a request for information. The user is to provide the number of write in candidates and the number of votes that are to be cast by a voter. The user also provides information as to whether or not the race is partisan or non-partisan. If the race is a partisan race, then the system is configured to provide additional requests for information on the number of candidates that each of the recognized parties on the ballot have for that particular race. In the example shown, the race is a partisan race with a single candidate from each of the following parties: Republican, Democrat, Libertarian, USTaxpayer, Green. The user identifies that there are no candidates for the race from either the Natural Law party or any individual with no party affiliation (NPA). After the information is provided, all of the information for the race has been completed.

Referring back to FIG. 3, the user determines if any additional contests exist for the ballot, at step 220. If so, the user can repeat step 210 by entering a second race. In the Example of FIG. 4, the user may enter the race for Secretary of State (SOS). In this case, again, the user identifies that there is a single write in spot, and that the voter is to select only a single candidate, and, that the nature of the race is a partisan race. In this case, the system provides all of the political parties and requests that the user provide the number of candidates for each one of the parties. In the example, a single candidate is running from each of the following parties: Republican, Democrat, Libertarian, USTaxpayer, and Natural Law. There is no candidate from the Green party and there is no candidate with NPA.

With reference to FIG. 3, the user again determines at step 220 if additional races exist with candidates. In this case, as there are two remaining races with candidates, step 210 is repeated again for each one. As shown in FIG. 4, there are indeed a total of two additional races with candidates. The two remaining races are both non-partisan races for Justices of the Supreme Court. In the case of a non-partisan race, the system requests information as to the total number of candidates, the number of write-in candidates, and the number of votes that the voter is to cast. In the case of the first election of the sample shown, there are three candidates, and two write in candidate spots, and the voter is to vote for a maximum of two candidates. In the second election of the sample shown, there are three candidates, and one write in candidate spot, and, the voter is to vote for a single candidate.

With no further races to enter with candidates, with reference to FIG. 3, at step 220, the user proceeds to step 230 wherein proposal information is provided to the system. In the example of FIG. 4, there are two proposals, namely, proposal 14-1 and 14-2. They are both identified in the dropdown menu as being proposals. In such an instance, no further information is required.

After each proposal, at step 240 (FIG. 3), the user determines if additional proposals exist. If no more such proposals exist, the end of the races and proposals has been reached. Once the user reaches the end of the races and proposals for the ballot, all of the information has been provided to the system necessary for the system to prepare a ballot test chart. In particular, the system proceeds through each of the promulgated rules one by one and determines the manner in which a ballot shall be marked to effectuate the rule. This is completed for each of the rules. The rules for Michigan are set forth by statute and rule as set forth above. Each one of the rules is uniformly applied by the system based on the information that is provided.

Once all of the rules have been reviewed, at step 250, the system has an initial determination of the different markings that must be placed on different ballots. The system then reviews the different markings to make a determination if any of the different required markings can be combined with other different markings, on the same ballot, to essentially optimize the information to a minimum number of ballots. For example, testing for a particular race or set of races may not interfere with the proposal section of a particular set of ballots. Thus, while no additional marks may be placed on certain races or certain portions of the ballot, the proposal section of the ballot can be utilized to test the compliance of the voting system with respect to the different proposals. This step provides a vast reduction in the number of test ballots, and such minimization provides a substantially faster creation of ballots and also substantially faster testing of the voting machine, as fewer numbers of ballots need to be introduced into the voting machine.

The system therefore determines which different markings for different sections can be combined on a single ballot without negatively affecting that which is to be counted. Thus, by combining the ballots, the system can reduce the number of ballots that need to be utilized for testing, as well as the number of ballots that are required to be filled out and fed into the machine. It will be understood that this optimization may be made and done integrally with the formation and creation of a chart, or may be done after creation of an initial test chart (with a user having the ability to receive either a test chart without optimization, or a test chart with optimization).

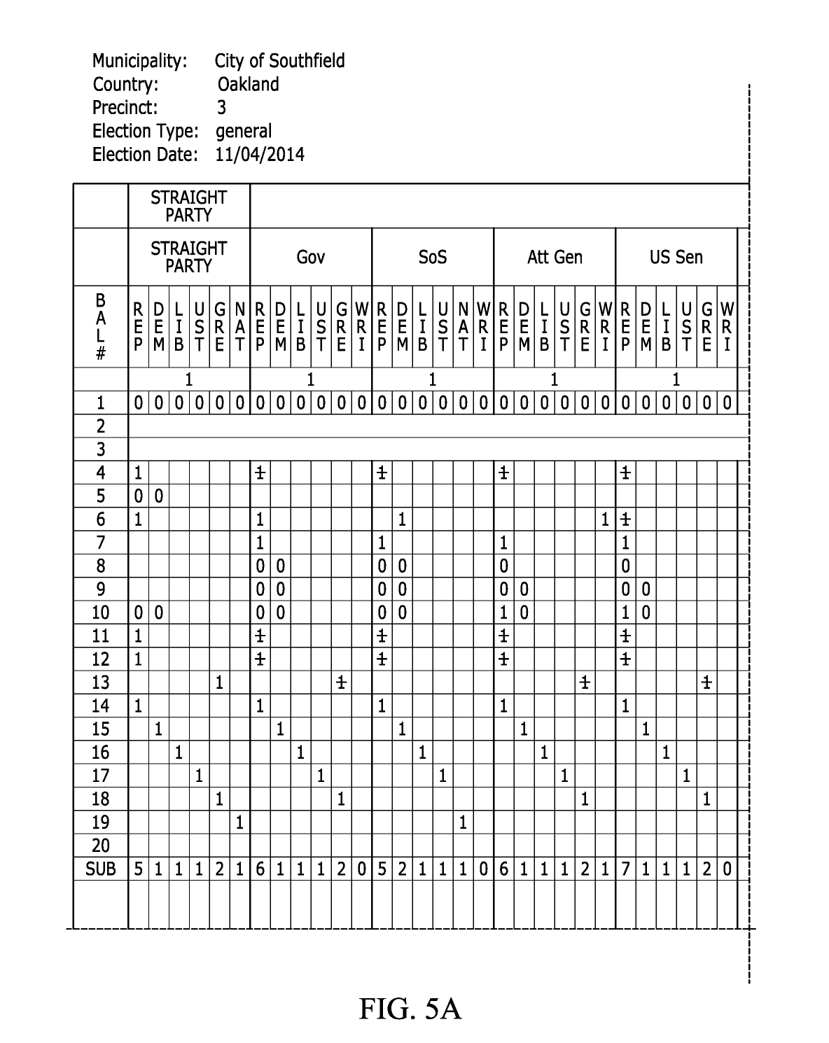

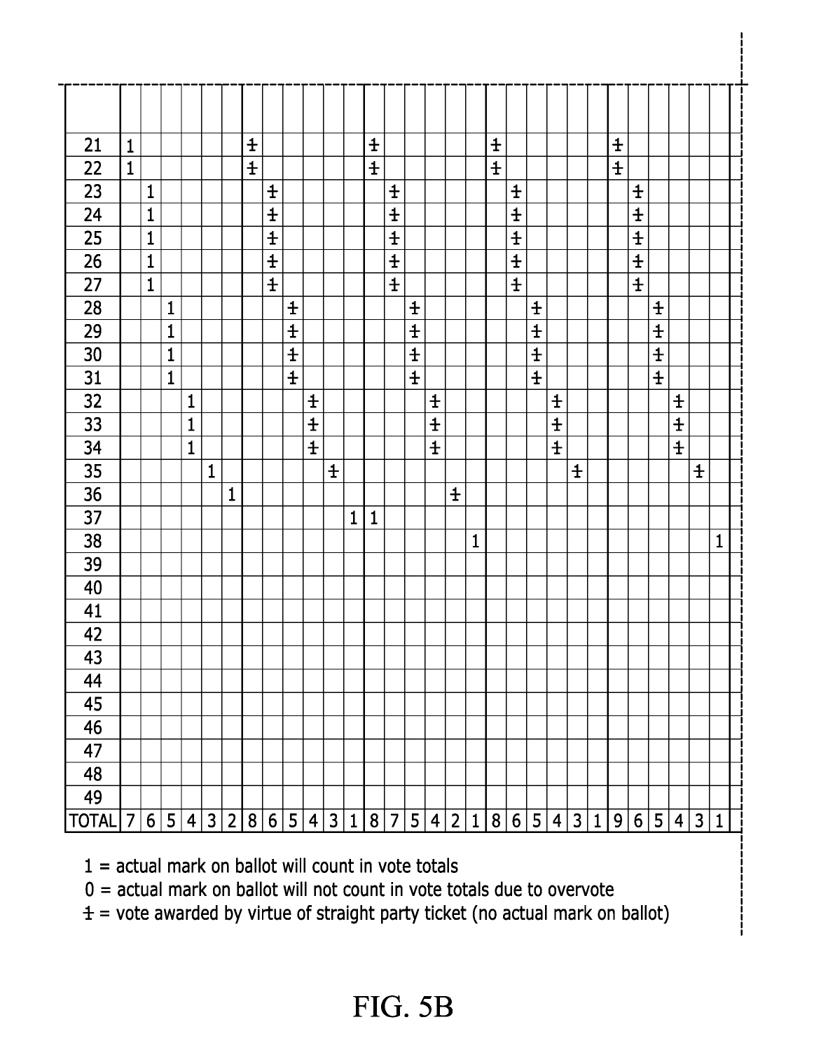

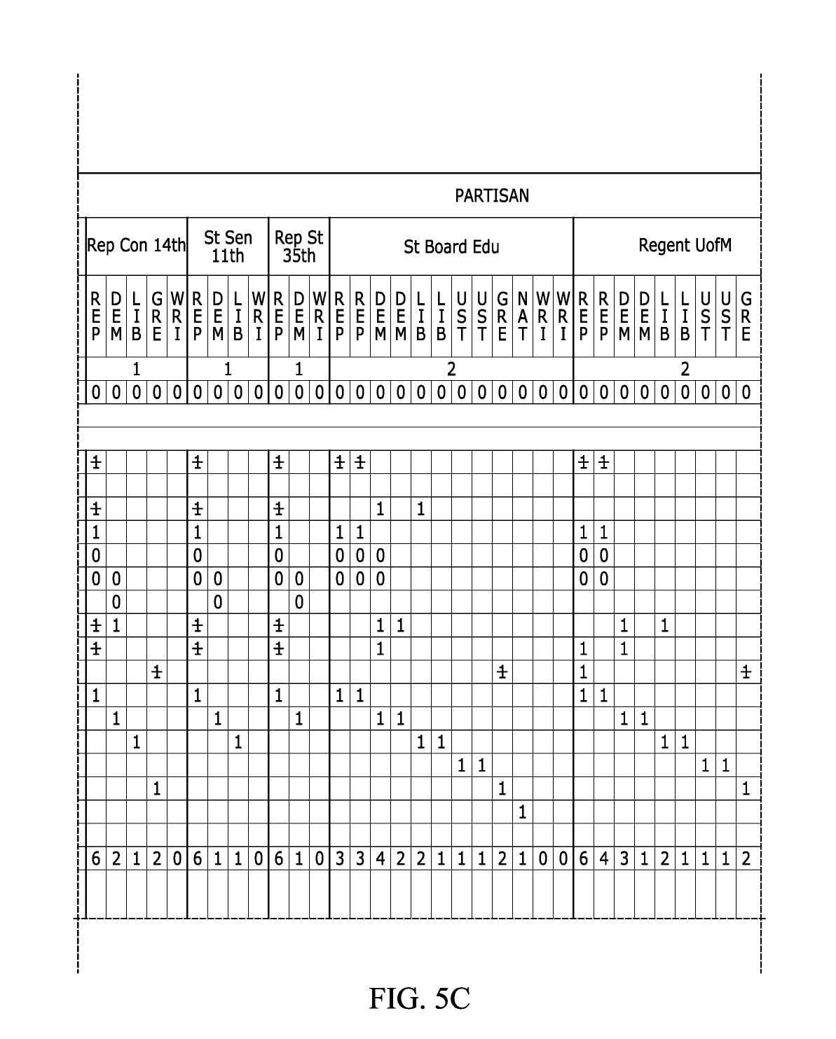

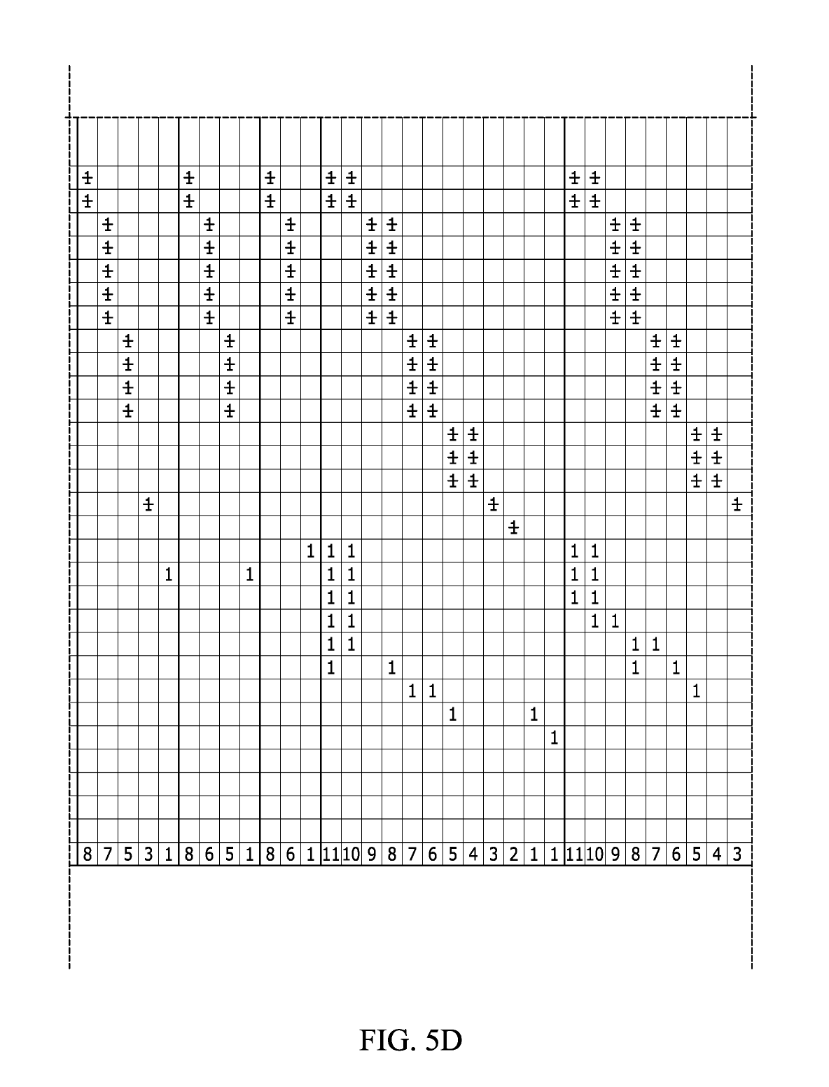

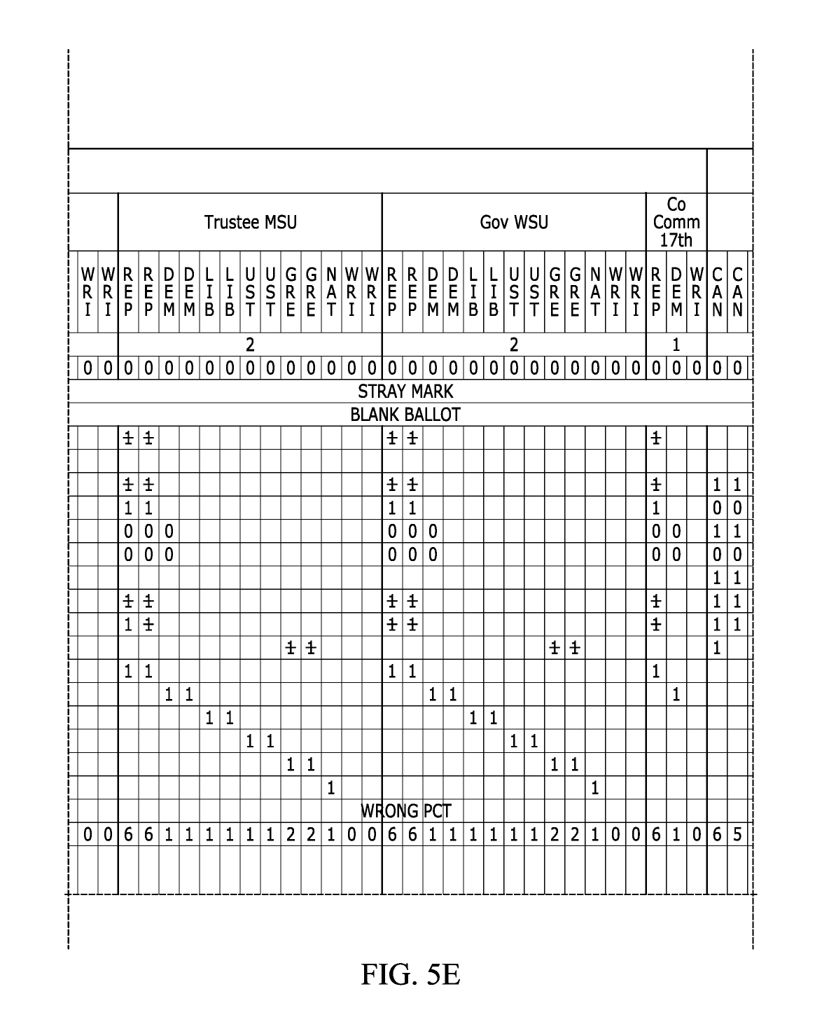

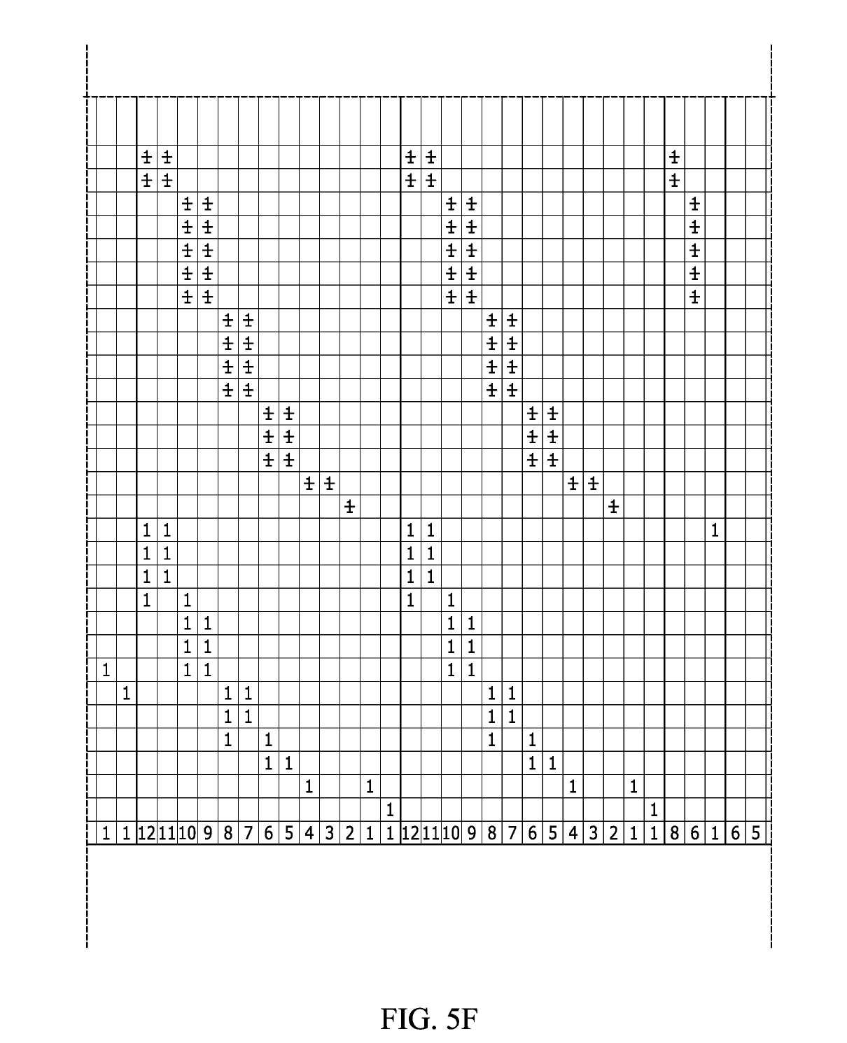

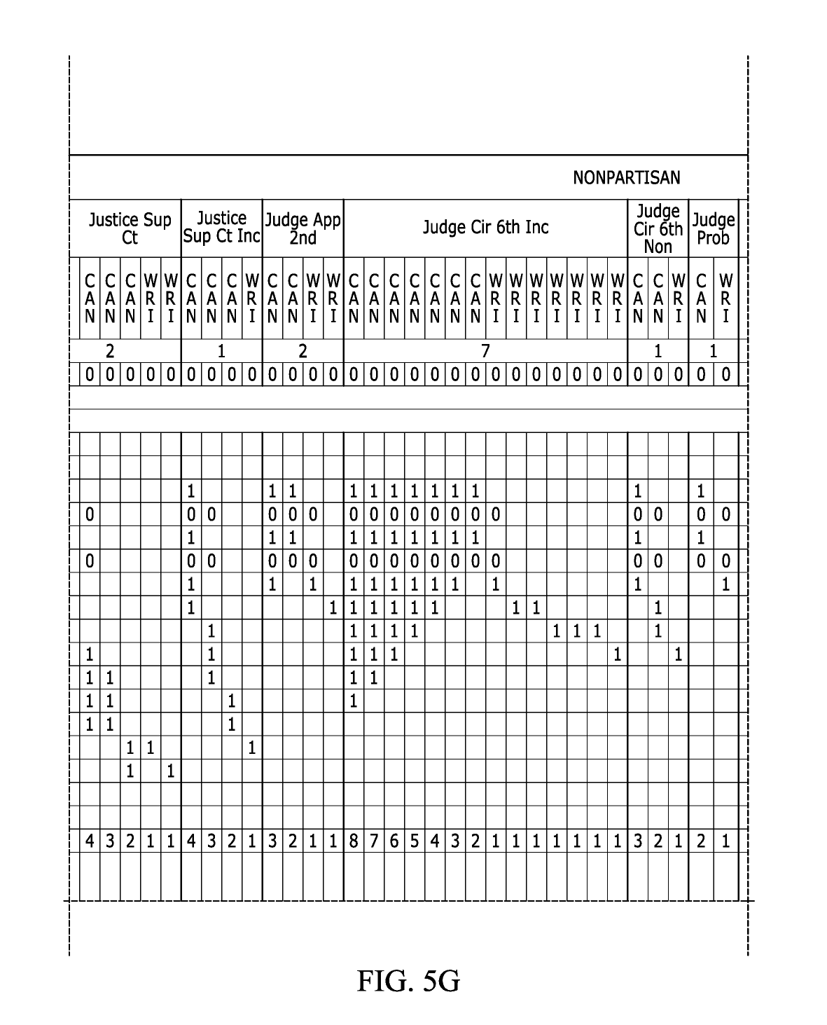

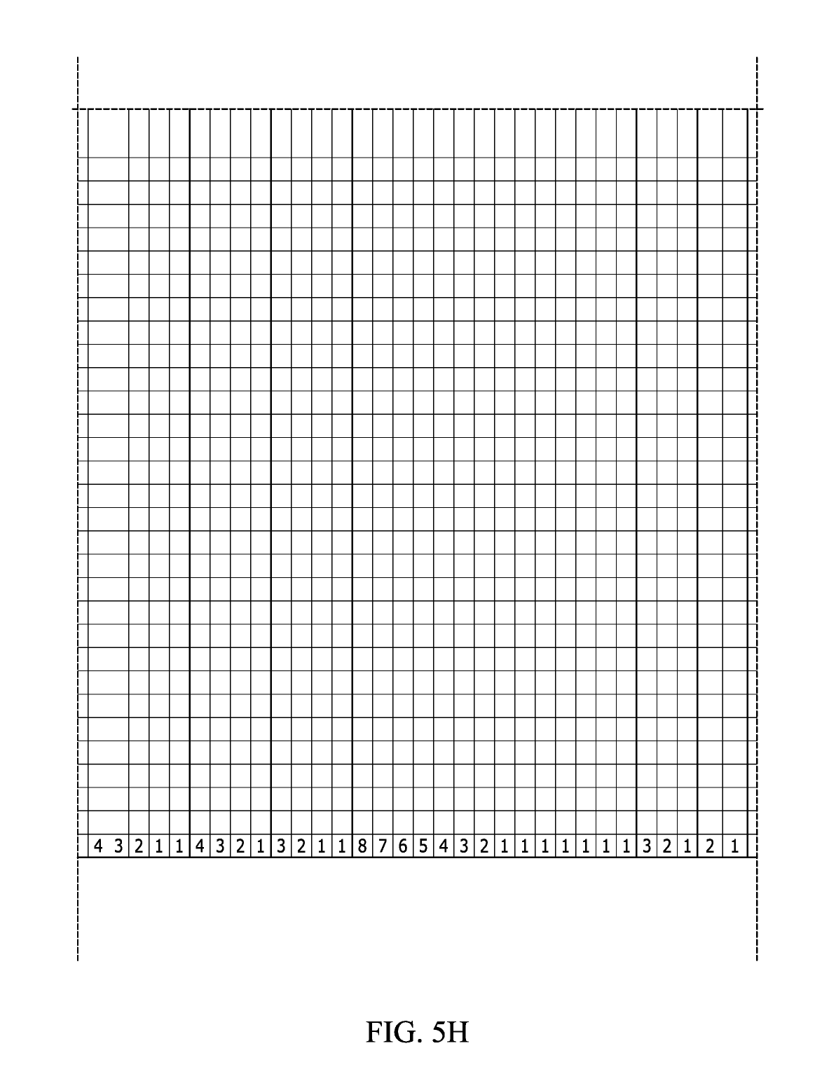

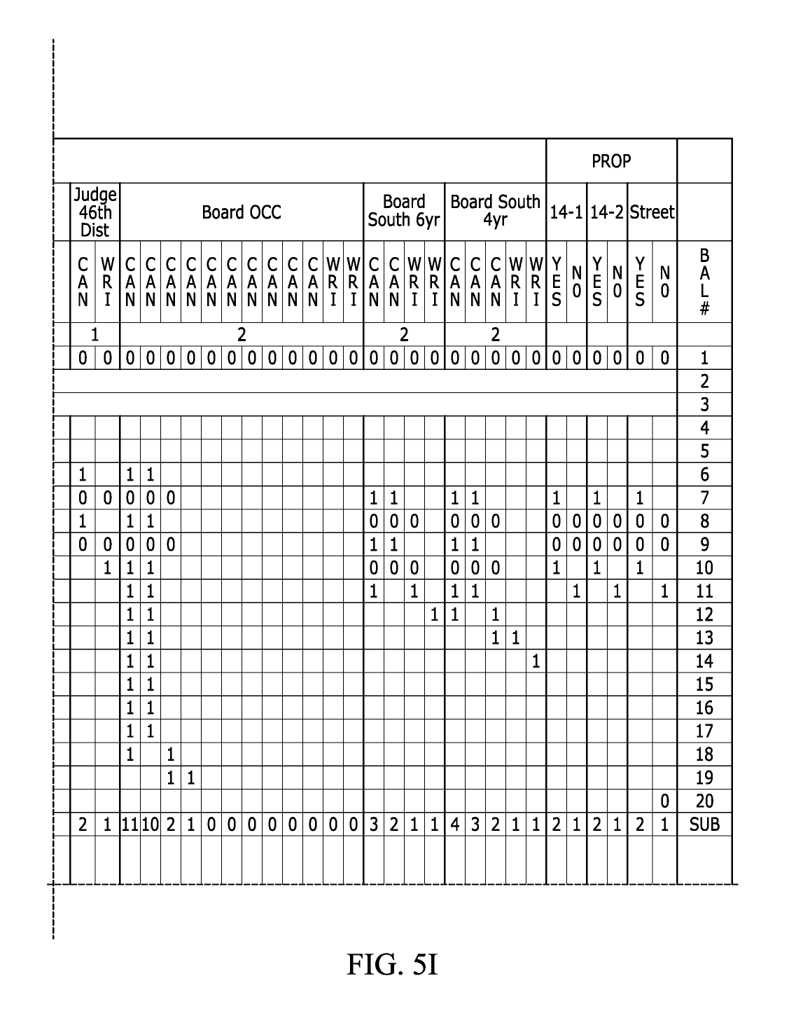

The system then generates the test chart at step 260 and provides the chart to the user. One such chart is shown in FIG. 5. In the chart, the rows represent the different ballots that must be prepared, and the columns represent different markings on each of the ballots. A 1 indicates that the ballot is to be marked and that the vote should count in the tally. A 0 indicates that the ballot is to be marked and that the vote does not count in the tally (for any number of different reasons). A blank indicates that the ballot is not marked for that race.

Referring again to FIG. 1, armed with the test chart 26, the user can then grab the number of ballots that the system has determined are required for the test, and proceed to mark the ballots according to the test chart that was created by the system to create the test ballots 28. It is also contemplated that the initial ballot may be provided to the system, and the system can read the ballot and create the requisite number of test ballots from the completed test chart.

Generally, these can then be electronically sent (in, for example, a PDF) to the user. The user can then run the test ballots 28 in the electronic voting equipment 30, as required under the law and promulgated rules. In other embodiments or configurations, the test ballots may be manually prepared based on the generated chart. The results from the electronic voting equipment is compared to the expected results. Any errors can then be determined through an analysis of the test chart, the ballots and the voting equipment.

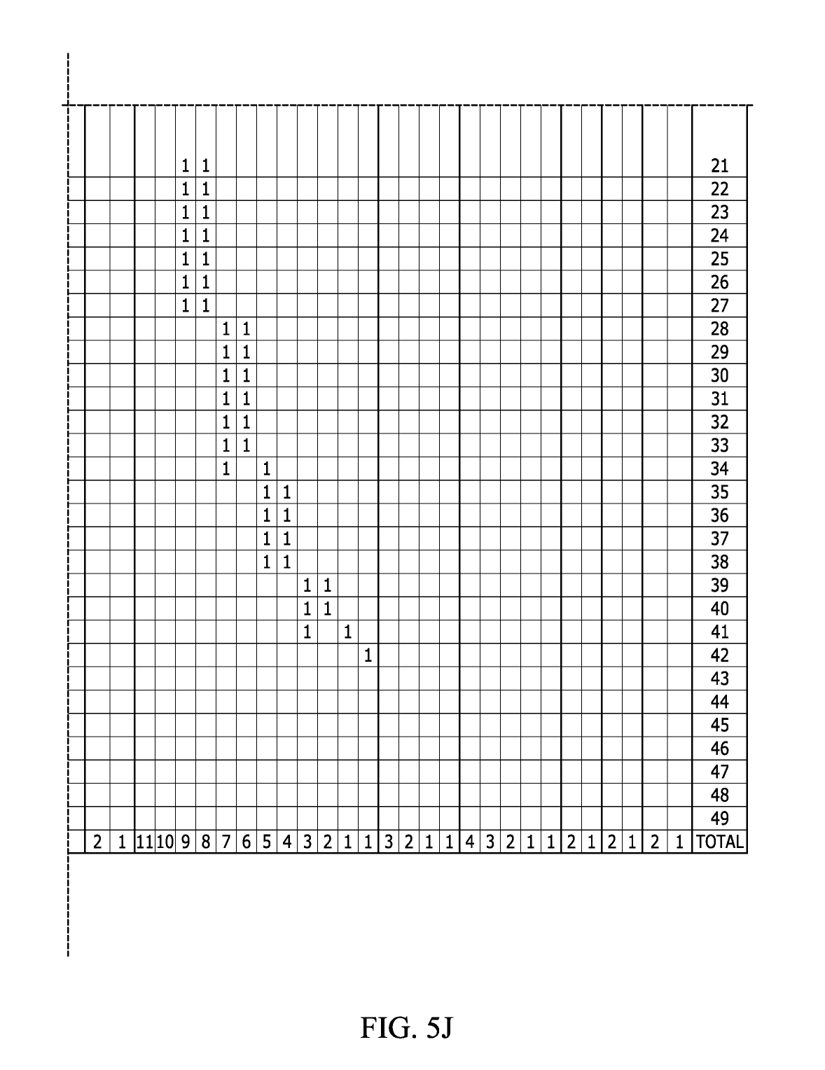

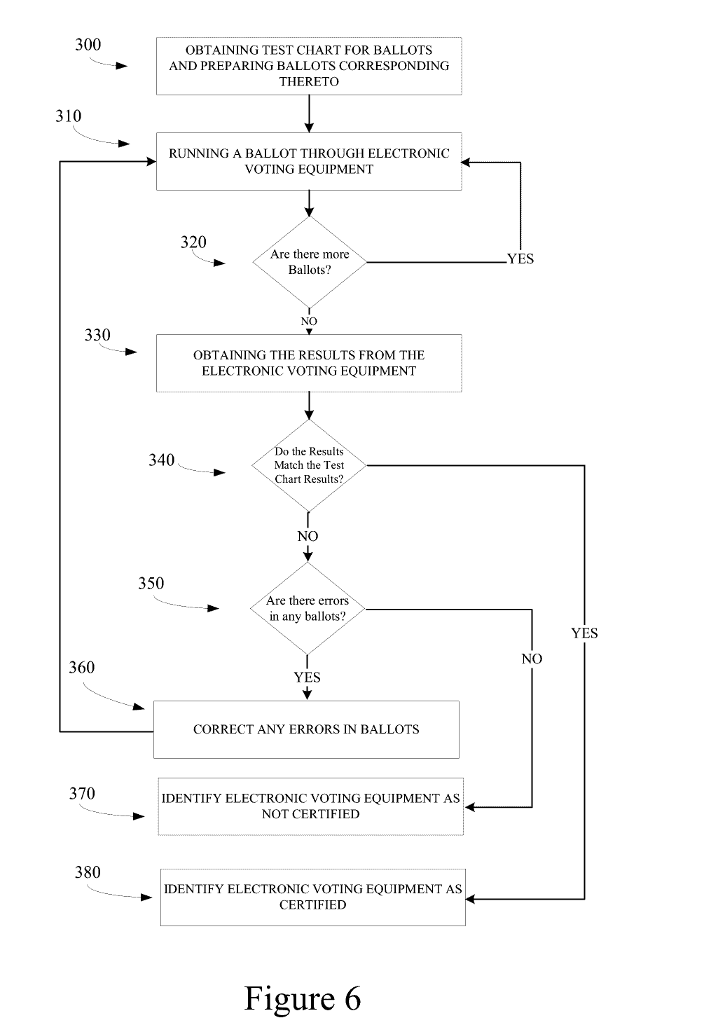

In more detail, and with reference to FIG. 6, a sample testing procedure is shown in flow chart form. In particular, first, the test chart is obtained and the test ballots are prepared corresponding to the test chart. In some configurations, the test charts are sent to an individual or groups of individuals so that they can be manually completed. In other configurations, the ballots can be automatically prepared by the system corresponding to the results of the charts. In either manner, or in some other manner, eventually the test ballots are prepared at step 300.

At steps 310 and 320, the ballots are run through the electronic voting equipment sequentially until all of the test ballots have been processed by the equipment. Once all have been run through the equipment, at Step 330, the electronic voting equipment is caused to provide the results that have been tabulated as a result of the test ballots being processed therethrough. Depending on the equipment, there is typically a procedure to either output data corresponding to the results, or to print the results directly from the electronic voting equipment.

At step 340, the results tabulated by the electronic voting equipment are compared to the expected results that are provided on the test chart. If these results correspond to each other, then the electronic voting equipment can be identified as certified at step 380. These test ballots can then be processed through other electronic voting equipment.

On the other hand, if, at step 340, the results from the electronic voting equipment do not match the expected results that are provided on the test chart, then the ballots are reviewed. In particular, the ballots as completed are reviewed against the test chart to determine if any of the ballots were improperly prepared or have any errors, at Step 350. If any errors are found, at step 360, the errors are corrected, and the ballots are re processed through the voting equipment, starting with step 310. If, in this re-processing, the results from the electronic voting equipment match the test chart, then, the electronic equipment is identified as being certified, at step 380.

On the other hand, if at step 350, it is determined that there are no errors in the ballots, and, consequently, the error is with the equipment, then at step 370, the electronic voting equipment is identified as not certified. From this step, a number of different steps may be undertaken. It may be that the portion of the electronic voting equipment that is not operation is directed to the scanning portion of the equipment, in other instances, other problems may arise. The system has properly identified that the particular piece of voting equipment is not properly operational, and that further review and analysis is necessary.

It will be understood that the system is not limited to a particular type of race or election. Indeed, the system is configured to be able to receive data for other types of elections, such as, for example, a partisan primary election, a non-partisan primary election, an election geared toward proposals, and any combination of different races. Indeed, there is also only practical limitations on the number of different races that can be entered (typically, these are controlled by the size of the ballot and the like, while the system may have only memory type, or file size restrictions, or theoretical restrictions).

Additionally, it will further be understood that the system is not limited to use in association with any particular set of rules or statutes. While the system is shown as implementing the rules and statutes for the State of Michigan, it will be understood that the system can be tailored for any other jurisdiction (i.e., any other state, among other jurisdictions). For example, the user may select the jurisdiction from a pull down menu or the like. The different jurisdictions offer different rules, and the system is configured to understand the application of different rules based on the selected jurisdiction.

It will further be understood that the system is configured so that if part of a ballot has been created, the user can save the work completed, and return to complete the work at a later time. Additionally, if an error has been found, it is possible to retrieve the previously entered information for a ballot to make changes and modifications thereto. Among other changes, it is contemplated that the different races on the entered information can be reorganized and re-ordered into a different order, so as to mimic a ballot, or for other purposes. Furthermore, it is also contemplated that data entered for a first ballot can be utilized, as, for example, a template, for a second ballot, thus, saving the time to re-enter the data that has already been entered.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. One or more computer storage media comprising computer-executable instructions for preparing a ballot test chart, the computer-executable instructions when executed by a computing device performing steps comprising:
receiving information pertaining to an election;
receiving information as to at least one of a candidate and a proposal;
reviewing a set of rules for the election with the information received;
determining a manner in which to mark a plurality of test ballots; and
providing the manner in which to mark a plurality of test ballots in the form of a test ballot chart.

2. The one or more computer storage media of claim 1 wherein the computer-executable instructions when executed by a computing device performing additional steps comprising:
optimizing the manner in which to mark a plurality of test ballots so as to minimize a quantity of test ballots required.

3. The one or more computer storage media of claim 1 wherein the step of receiving information of at least one of a candidate and a proposal further comprises the step of:
receiving information as to a plurality of candidates for a plurality of different races.

4. The one or more computer storage media of claim 3 wherein the step of receiving information as to at least one of a candidate and a proposal further comprises the step of:
receiving information as to a plurality of proposals.

5. The one or more computer storage media of claim 1 wherein the computer-executable instructions when executed by a computing device performing additional steps comprising:
providing a plurality of test ballots that are marked according to the test ballot chart.

6. The one or more computer storage media of claim 1 wherein the test ballot chart provides a plurality of rows corresponding to an individual ballot and a plurality of columns pertaining to the different candidates and proposals.

7. A method for providing instructions for preparing a ballot test chart, comprising the steps of:
receiving information pertaining to an election;
receiving information as to at least one of a candidate and a proposal;
reviewing a set of rules for the election with the information received;
determining a manner in which to mark a plurality of test ballots; and
providing the manner in which to mark a plurality of test ballots in the form of a test ballot chart.

8. The method of claim further comprising the steps of:
optimizing the manner in which to mark a plurality of test ballots so as to minimize a quantity of test ballots required.

9. The method of claim 7 wherein the step of receiving information as to at least one of a candidate and a proposal further comprises the step of:
receiving information as to a plurality of candidates for a plurality of different races.

10. The method of claim 7 wherein the step of receiving information as to at least one of a candidate and a proposal further comprises the step of:
receiving information as to a plurality of proposals.

11. The method of claim 7 further comprising the step of:
providing a plurality of test ballots that are marked according to the test ballot chart.

12. The method of claim 7 wherein the test ballot chart provides a plurality of rows corresponding to an individual ballot and a plurality of columns pertaining to the different candidates and proposals.

13. A ballot test chart preparing system comprising:
a receiving component configured to receive information pertaining to an election;
a second receiving component configured to receive information as to at least one of a candidate and a proposal;
a reviewing component configured to review a set of rules for the election with the information received;
a determining component configured to determine a manner in which to mark a plurality of test ballots; and
a providing component configured to provide the manner in which to mark a plurality of test ballots in the form of a test ballot chart.

14. The system of claim 13 further comprising an optimizing component configured to optimize the manner in which to mark a plurality of test ballots so as to minimize a quantity of test ballots required.

15. The system of claim 13 wherein the second receiving component is configured to receive information as to a plurality of candidates for a plurality of different races.

16. The system of claim 13 wherein the at least one of a candidate and a proposal further comprises information as to a plurality of proposals.

17. The system of claim 13 further comprising a providing component that is structurally configured to provide a plurality of test ballots that are marked according to the test ballot chart.

18. The system of claim 13 wherein the test ballot chart provides a plurality of rows corresponding to an individual ballot and a plurality of columns pertaining to the different candidates and proposals.
